(19) United States
(12) Patent Application Publication
(10) Pub. No.: US 2022/0333035 A1
(43) Pub. Date: Oct. 20, 2022

(54) REMOVAL OF MIU AND METALS FROM FEEDSTOCK

(71) Applicants: Leland Colin Doyle, Phoenix, AZ (US); Michael P. Doyle, Carmel, CA (US)

(72) Inventors: Leland Colin Doyle, Phoenix, AZ (US); Michael P. Doyle, Carmel, CA (US)

(21) Appl. No.: 17/722,001

(22) Filed: Apr. 15, 2022

Related U.S. Application Data
(60) Provisional application No. 63/176,772, filed on Apr. 19, 2021.

(51) Int. Cl. C11B 3/00; B01D 11/04; B01D 17/02; B01D 17/12; C11B 3/16

(52) U.S. Cl. CPC C11B 3/006; B01D 11/0492; B01D 17/0217; B01D 17/12; C11B 3/16; C11B 3/001

(57) ABSTRACT

MIU and metals are removed from Tallow or Seed based oils (feedstock) utilizing water treated by reverse osmosis and specific operating conditions using a very high RCF centrifuge. A relatively small quantity of the RO water (3% to 20% by weight) is added to the feedstock to attract the MIU and metals. The mixture is then centrifuged at an RCF in excess of approximately 6500. Temperature, flow rate to control Residence time and backpressure in the centrifuge are selected. The process separates the RO water with the MIU and metals from the feedstock.

### CROSS-REFERENCES TO RELATED APPLICATIONS

This application claims priority from U.S. provisional Application No. 63/176,772, filed Apr. 19, 2021, incorporated by reference in its entirety.

### BACKGROUND

With the growth of renewable fuels, feedstock to produce these fuels is becoming expensive compared to crude oil as use of the feedstock is increasing. Further, supplies of these feedstocks are becoming short in supply. The feedstocks' origin is either seed based or animal based. Typical seed oils are soy, rapeseed (canola) or more recently hemp oil. Animal based oils are poultry, beef, pork, lamb, etc. Variants of these oil are previously used cooking oil or other. These oils are either converted to methyl ester (biofuel) or renewable fuel that is produced by hydrotreating the oils resulting in a fuel that is almost indistinguishable from petroleum based fuels.

The problem with these feedstock oils is that they contain moisture, insolubles and unsoponifiables (MIU) and metals, most notably phosphorus. These contaminants pose processing problems in the refineries, especially for renewable fuels. The metals, for example, will contaminate the catalysts in the refinery. This is not desirable because if the catalysts become ineffective the output at the refinery will be reduced. Additionally, catalysts are expensive to replace. In a large refinery, the cost may exceed a quarter million dollars to replace catalysts in one processor.

Regarding moisture, one existing method of removing water in the feedstock is to boil it off. However, this is inefficient, expensive and effects the composition of the feedstock.

The insolubles and unsoponifiables are essentially gums that coat reactor surfaces and coat other chemicals in the feedstock and those used in refinery processing. These gums are known to cause fires in treatment facilities. Removal of these gums from feedstock by existing methods is difficult. If not sufficiently removed, the insolubles and unsoponifiables cause reductions in the yields of the final refined product. Also, they are essentially junk that becomes a residue that has to be removed from the processing equipment at the refinery.

Current methods of purifying these oils have fallen mostly on the use of filter presses. These presses use filter aids. The required daily amount of these filter aids poses a severe disposal and production problem. There has been then a severe need for a cost-effective alternative. What we developed, quite by surprise, is a method based on controlled operating conditions and the use of reverse osmosis water. After 3 years of lab work and a full scale test process skid, we are able to obtain a 70% reduction in the metals with removal of most MIU.

Using the processes described herein, we have achieved surprisingly good results in tests on commercial quantities of feedstock. For example, when metals were present in quantities of 200 ppm or more, we have achieved reductions of over 80%, meeting suggested renewable refinery specifications, most notably the low combined total of metals.

### SUMMARY OF THE INVENTION

MIU and metals are removed from Tallow or Seed based oils (feedstock) utilizing water treated by reverse osmosis and specific operating conditions using a very-high Ref centrifuge. A relatively small quantity of the RO water (3% to 20% by weight) is added to the feedstock to attract the MIU and metals. The mixture is then centrifuged at an RCF in excess of approximately 6500. Temperature, flow rate to control Residence time and backpressure in the centrifuge are selected. The process separates the RO water with the MTU and metals from the feedstock.

### BRIEF DESCRIPTION OF THE DRAWINGS

FIG. 1 is a schematic of one embodiment of the claimed process including elements to illustrate flow and operations that may be used in a commercial process but not all of which are necessary to carry out the inventions claimed herein.

FIG. 1A is a partial breakout of a portion of FIG. 1

FIG. 2 is a table of test data of a commercial quantity of feedstock comparing the content of raw and treated lots of feedstock.

### DETAILED DESCRIPTION OF THE PREFERRED EMBODIMENTS

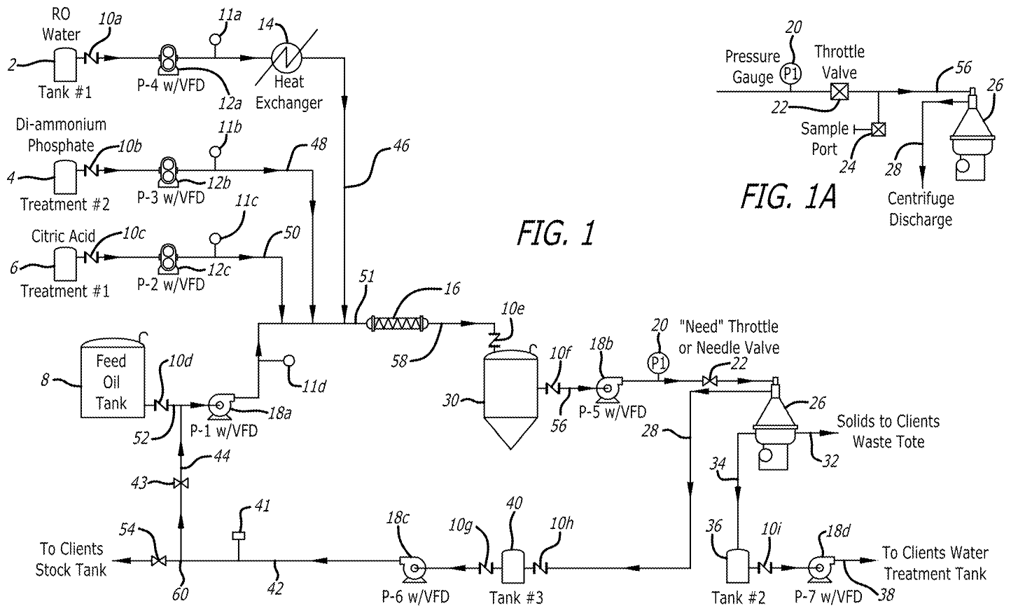

FIG. 1 depicts the flow and processes used by one embodiment of the disclosure. This is one example of the process being disclosed herein. Other embodiments will be also be discussed. Not all of the features, processes and equipment depicted in FIG. 1 are required for all of the embodiments discussed below. As will be explained, some of these features are optional. Choice of embodiments depends on the composition of the feedstock being processed. As is always the case, the inventions are defined by the claims.

The first step in the process is determining the composition of the feedstock oil, which resides in tank 8, using laboratory methods well known in the art. The feedstock may comprise an animal oil, seed based oil or a combination thereof. The feedstock oil from tank 8 may contain moisture, insolubles and unsoponifiables (MIU) and metals, most notably phosphorus. The processes explained below are tailored to the composition of the feedstock.

In this first embodiment, RO (reverse osmosis) water is stored in RO water tank 2. RO water is required in all embodiments of the inventions. Enough RO water is metered out to provide a 3% to 20% by weight addition to the feedstock oil that is stored in tank 8. The feedstock oil is piped out of tank 8 through conduit 52. As explained later, product that does not meet finished product specifications may also enter the stream via conduit 44 for further processing. Di-ammonium phosphate is stored in Di-ammonium phosphate tank 4. Its use is not required in all embodiments of the inventions as discussed below in the alternative embodiments. It may be added if there are excessive metals in the feedstock, especially phosphorus. Citric acid is stored in citric acid tank 6. Citric acid is also not required in all embodiments of the inventions. It may be added to assist in the removal of Flow from each of these tanks is controlled by valves 10a, 10b and 10c respectively, and is monitored by flow meters 11a, 11b, 11c and follows the oil flow master meter 11d.

In general, the RO water (due to its excellent solvency and desire to attract metals) is used alone as the solvent and may remove all of the undesirables by itself. If that is insufficient, then citric acid can be added to the RO water to assist in the removal of the MIU's. If necessary, di-ammonium phosphate is added to the RO water to remove especially difficult metals like phosphorus. Generally, citric acid and di-ammonium phosphate are not used at the same time. One may choose to run the process with RO water only as a first pass, the next pass could include the addition of citric acid, and then a third pass could include the addition of di-ammonium phosphate to the RO water. The material to be further processed enters by conduit 44.

By laboratory analysis, the quantities of RO water, citric acid and/or di-ammonium phosphate needed to extract the impurities in the feedstock are determined, and the flows are adjusted as necessary. Adjustments to the flows may be made in accordance with computer instructions. The valves 11a, 11b and 11c pass appropriate quantities of RO water, citric acid and/or di-ammonium phosphate as had been determined. Pumps with variable frequency drives 12a, 12b and 12c move the fluids from tanks 2, 4 and 6 respectively. The RO water is pumped through conduit 46 after passing through heat exchanger 14. The Di-ammonium phosphate, if being used, is pumped into conduit 48 and the citric acid, if being used, is pumped into conduit 50. These one, two and/or three streams enter conduit 51, to be joined by product exiting from pump 18a. Tank 8 contains the feedstock oil base to be treated according to the present disclosure. The feedstock oil base passes through valve 10d into conduit 52. These fluids enter in-line mixer 16 where they are combined into a mixture flowing into conduit 58.

The flow rate of the mixture in conduit 58 is controlled by valve 10e and the mixture then enters mixing tank 30. Alternatively, this mixing tank 30 may not be necessary if the in-line mixer 16 is configured to thoroughly mix the product by itself. The product from mixing tank 30 is pulled through butterfly valve 10f into conduit 56 by pump 18b. Pressure of the liquid is monitored by pressure gauge 20, and flow is further controlled by valve 22. FIG. 1A depicts a portion of the centrifuge piping and includes a sample port 24 for withdrawing fluid for inspection. It should be understood that sample ports and pressure gauges may be added at almost any point in the process.

The product in conduit 58, after mixing in vessel 30, exits in conduit 56 and enters centrifuge 26 where it is centrifuged at 6500 RCF or above. Waste product, including MIU and metals, is sent to a waste tote via conduit 32. Recovered water is piped through conduit 34 into storage tank 36. It is then piped through valve 10i by pump 18d along conduit 38 into either a treatment tank or as a waste stream.

The treated oil exits centrifuge 26 via conduit 28 for storage in tank 40, which has valves 10h and 10g controlling the flow rate. Pump 18c, preferably a variable frequency pump, moves the treated oil along conduit 42, past junction 60 through valve 54 and then into the client's stock tank. At junction 60, the direction of flow can be change to enter conduit 44. As discussed above, this is done in order to reprocess the material if the undesirables have not been removed sufficiently to meet delivery specifications. Whether the material needs to reprocessed is determined at sample port 41. Treated material is withdrawn at sample port 41 and analyzed. If it is determined that reprocessing is necessary, the flow is diverted by closing valve 54 and valve 10d and opening valve 43. The treated oil will then be diverted through conduit 44 into conduit 52 to enter the processing system discussed above. If reprocessing is not necessary, valve 43 remains closed and valve 54 is opened.

Sample ports (see e.g., Sample Port 24) may be added at any location in the system to determine the composition, temperature and pressure at any point.

A second embodiment will now be presented. In this embodiment of this disclosure, RU water is pumped through conduit 46 after passing through heat exchanger 14 to raise the temperature to approximately 160 F. Enough RO water is metered out to provide a 3% to 20% by weight addition to the feedstock oil that is stored in tank 8. The feedstock may comprise an animal oil, seed based oil or a combination thereof. The feedstock oil from tank 8 may contain moisture, insolubles and unsoponifiables (MIU) and metals, most notably phosphorus. In this embodiment, the combination of RO water and feedstock oil is pumped through in-line mixer 16 and mixer 30 and then is centrifuged at 6500 RCF or above. By calculation according to principals known to persons skilled in the art, a residence time and backpressure are determined for the centrifuging step depending on the feedstock so that the maximum amount of water remaining in the exiting mixture is no more that 0.5% by weight of oil. The centrifuged mixture exits the centrifuge into storage and the removed solids and water are sent to either waste or other processing.

A third embodiment will now be presented. In this embodiment, a feedstock comprising an animal oil, a seed-based oil or a combination thereof is provided. Also provided is water purified by a reverse osmosis process (RO water). The RO water is added to the feedstock in the ratio of 3% to 20% by weight of water to feedstock. This feedstock and water mixture is thoroughly mixed in an in-line mixer and/or a mixing tank supplying the centrifuge. The temperature of the feedstock/water mixture is controlled to be between 150 F and 160 F. Thereafter the water/feedstock mixture is centrifuged at 6500 RCF or above. The feedstock/water input to the centrifuge is controlled to be at or below 50% of the rated maximum throughput of the centrifuge providing increased residence time in the centrifuge. The back pressure on the centrifuge is controlled to be between at least 25 psi to a maximum of 60 psi. The residence time and backpressure used in the centrifuging step is controlled, depending on the feedstock mixture, so that the maximum amount of water remaining after centrifuging is no more than 0.5% by weight of oil.

In a fourth embodiment, when excessive metals are present in the feedstock, especially, phosphorus, the second and third embodiments above could be modified by adding diammonium phosphate to the RO water at the rate of 0.01% to 0.1% by weight in order to achieve as satisfactory finished product.

In a fifth embodiment, when excessive metals are present in the feedstock, especially, phosphorus, and depending on the mixture of components in the feedstock, the second and third embodiments above could be modified by adding diammonium phosphate to the RO water at the rate of 0.01% to 1.0% by weight in order to achieve as satisfactory finished product.

In a sixth embodiment, depending on the mixture of components in the feedstock, the second and third embodiments above could be modified by adding citric acid to the RO water in the range of 0.01% to 0.05% by weight.

Lab work verified the processes during development thereof, as summarized below. The lab work centered around using moderate temperature, RO water and relative centrifugal force (RCF). The purpose of the RO water is that by removing all minerals and metals from the water, it creates a solvent that wants to extract the minerals and metals to balance itself. Then, using the water in a 3 to 20% by weight addition to the oil (for example, poultry oil) at 160 F, in-line mixed and fed to a high RCF centrifuge. The centrifuge operates above 6500 RCF and even at 7000 RCF. At this RCF, in an RO solvent system, the metals and MIU are mobile and move to the RO water phase.

It is necessary to give the water and oil mixture sufficient residence time in the centrifuge. To accomplish this, the centrifuge may be operated at ½ the rated gpm input to the centrifuge. As an example, a 50 gpm centrifuge would be fed at 23 gpm to 25 gpm. This gives residence time for extraction of the undesirables.

An important operating condition is the back pressure on the centrifuge. It is chosen to maintain the correct water oil interface for the maximum removal of the water from the mixture being processed to below 0.5% by weight of oil.

As an alternative, more than 3% to 20% water may be added to the oil being processed, whether it be poultry oil or another feedstock. Success may be had using as much as 20% water, which removes higher amounts of unwanted elements and compositions. Using a greater amount of water will require more centrifuging steps as described above. In other words, more centrifuges may be added to the process.

As another alternative, the lab work proved that citric acid may be added to the RO water in the range of 0.01% to 0.05% by weight.

As another alternative, diammonium phosphate may be added to the RO water at a rate of about 0.01% to 1.0% by weight. This will further reduce the metals in the mixture by increasing the attraction of the metals to the RO. It will also further reduce nitrogen containing compounds. Depending on the composition of the feedstock, a greater amount of diammonium phosphate may be added.

If necessary, in order to reduce the metals to between 10 ppm to 20 ppm (UOP specification) additional diammonium phosphate may be added. Alternatively, or additionally, the process described above may be repeated with or without the addition of diammonium phosphate if necessary to reduce the metals.

Example of Lab Testing.

The following is a full scale test run and the associated operating conditions.

Feed rate of untreated oil: 23 gpm

RO water feed rate: 1.3 gpm

RO water temp: 150 F

Reactor vessel temp: 160 F

Centrifuge back pressure: 37 to 48 psi

Combined flow discharging from centrifuge: 23 to 25 gpm

Oil was dark before treatment and was amber colored after. Viscosity is lower after treatment.

Test data before and after treatment with the disclosed process is shown below. The elemental analysis of the RAW FEED BEEF TALLOW is for the untreated sample. The elemental analysis of the BEEF TALLOW AFTER PROCESSING was for the same sample after treatment with the disclosed process.

Beef Tallow

Raw Feed

ASTM D5185 Elemental Analysis

| | |
|---|---|
| Aluminum, ppm | <1 |
| Antimony, ppm | <1 |
| Barium, ppm | <1 |
| Boron, ppm | <1 |
| Cadmium, ppm | <1 |
| Calcium, ppm | 18 |
| Chromium, ppm | <1 |
| Copper, ppm | <1 |
| Iron, ppm | 4 |
| Lead, ppm | <1 |
| Magnesium, ppm | 3 |
| Manganese, ppm | <1 |
| Molybdenum, ppm | <1 |
| Nickel, ppm | <1 |
| Phosphorus, ppm | 90 |
| Potassium, ppm | 58 |
| Silicon, ppm | 2 |
| Silver, ppm | <1 |
| Sodium, ppm | 65 |
| Strontium, ppm | <1 |
| Tin, ppm | <1 |
| Titanium, ppm | <1 |
| Vanadium, ppm | <1 |
| Zinc, ppm | 1 |

Beef Tallow

After Processing

ASTM D5185 Elemental Analysis

| | |
|---|---|
| Aluminum, ppm | <1 |
| Antimony, ppm | <1 |
| Barium, ppm | <1 |
| Boron, ppm | 2 |
| Cadmium, ppm | <1 |
| Calcium, ppm | 3 |
| Chromium, ppm | <1 |
| Copper, ppm | <1 |
| Iron, ppm | 2 |
| Lead, ppm | <1 |
| Magnesium, ppm | 1 |
| Manganese, ppm | <1 |
| Molybdenum, ppm | <1 |
| Nickel, ppm | <1 |
| Phosphorus, ppm | 23 |
| Potassium, ppm | 12 |
| Silicon, ppm | 1 |
| Silver, ppm | <1 |
| Sodium, ppm | 10 |
| Strontium, ppm | <1 |
| Tin, ppm | <1 |
| Titanium, ppm | <1 |
| Vanadium, ppm | <1 |
| Zinc, ppm | 1 |

A few of the significant reductions can be pointed out as follows.

Calcium was reduced from 18 ppm to 3 ppm.

Iron was reduced from 4 ppm to 2 ppm.

Magnesium was reduced from 3 ppm to 1 ppm.

Phosphorus was reduced from 90 ppm to 23 ppm.

Potassium was reduced from 58 ppm to 12 ppm.

Silicon was reduced from 2 ppm to 1 ppm.

Sodium was reduced from 65 ppm to 10 ppm.

The tests noted that there was a higher reduction of unwanted elements in animal oils than in seed oils. The process would be adjusted to meet the UOP specification in effect.

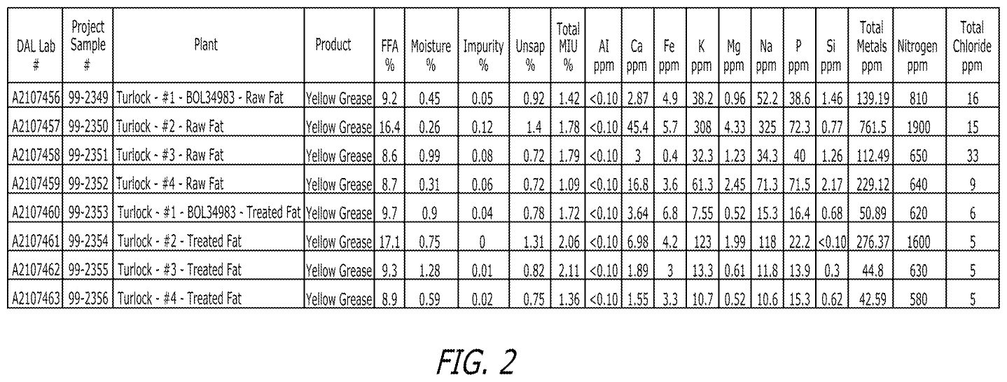

FIG. 2 is a table of test data of a commercial quantity of feedstock comparing the content of raw and treated lots of feedstock. The table shows the raw (untreated) content of each sample and the final treated content of that sample. The data show significant reductions in the components of major concern; namely, the Total Metals and Potassium (K). For example, Turlock #1 Raw Fat contained Total Metals of 139.19 ppm and K of 38.2 ppm. Turlock #1 Treated contained Total Metals of only 50.89 ppm and K of 7.55 ppm. Turlock #2 Raw Fat contained Total Metals of 761.5 ppm and K of 308 ppm. Turlock #2 Treated contained Total Metals of only 276.37 ppm and K. of 123 ppm. Turlock #3 Raw Fat contained Total Metals of 112.49 ppm and K of 32.3 ppm. Turlock #3 Treated contained Total Metals of only 44.8 ppm and K of 13.3 ppm. Turlock #4 Raw Fat contained Total Metals of 229.12 ppm and K of 61.3 ppm. Turlock #4 Treated contained Total Metals of only 42.59 ppm and K of 10.7 ppm.

Reasonable variation and modification are possible within the scope of the foregoing disclosure, the drawing and the appended claims of the invention, the essence of which is that there has been provided methods for removing MIU and metals from feedstock. Numerous variations and improvements are possible by those skilled in the art. Therefore, the claims define the invention, which is not limited to the disclosure above.

We claim:

1. A process for removing MIU and metals from a feedstock comprising the steps:
providing a feedstock comprising an animal oil, a seed based oil or a combination thereof;
providing water purified by a reverse osmosis process (RO water);
adding the water to the feedstock in the ratio of 3% to 20% by weight of water to feedstock;
centrifuging the water/feedstock mixture at 6500 RCF or above; and,
determining a residence time and backpressure used in the centrifuging step depending on the feedstock so that the maximum amount of water remaining is no more than 0.5% by weight of oil;

2. A process for removing MIU and metals from oil (feedstock) comprising the steps:
providing a feedstock comprising an animal oil, a seed-based oil or a combination thereof;
providing water purified by a reverse osmosis process (RO water);
adding the water to the feedstock in the ratio of 3% to 20% by weight of water to feedstock;
thoroughly mixing the feedstock water mixture in a feed vessel supplying the centrifuge that provides 15 minutes of mixing based on the feed rate to the centrifuge;
controlling the temperature of the feedstock/water mixture to between 150 and 160 F;
centrifuging the water/feedstock mixture at 6500 RCF or above;
controlling the feedstock/water input to the centrifuge at or below 50% of the rated maximum throughput of the centrifuge providing increased residence time in the centrifuge;
controlling the back pressure on the centrifuge to at least 25 psi to a maximum of 60 psi; and
controlling the residence time and backpressure used in the centrifuging step depending on the feedstock so that the maximum amount of water remaining is no more than 0.5% by weight of oil.

3. The process of claim 1 further comprising:
determining by prior lab work a quantity of diammonium phosphate to be added to the RO water to facilitate the removal of metals from the feedstock; and
adding said quantity of diammonium phosphate to the RO water.

4. The process of claim 2 further comprising:
determining by prior lab work a quantity of diammonium phosphate to be added to the RO water to facilitate the removal of metals from the feedstock; and
adding said quantity of diammonium phosphate to the RO water.

5. The process of claim 1 further comprising:
adding diammonium phosphate to the RO water at the rate of 0.01% to 0.1% by weight.

6. The process of claim 2 further comprising:
adding diammonium phosphate to the RO water at the rate of 0.01% to 0.1% by weight.

7. The process of claim 1 further comprising:
adding diammonium phosphate to the RO water at the rate of 0.01% to 1.0% by weight.

8. The process of claim 2 further comprising:
adding diammonium phosphate to the RO water at the rate of 0.01% to 1.0% by weight.

9. The process of claim 1 further comprising:
adding citric acid to the RO water in the range of 0.01% to 0.05% by weight.

10. The process of claim 2 further comprising:
adding citric acid to the RO water in the range of 0.01% to 0.05% by weight.
